(19) United States
(12) Patent Application Publication
(10) Pub. No.: US 2026/0095622 A1
(43) Pub. Date: Apr. 2, 2026

(54) METHOD AND APPARATUS FOR VIDEO DISPLAY OF CLOUD SERVICE, DEVICE, STORAGE MEDIUM, AND SYSTEM

(71) Applicant: CLOUD INTELLIGENCE ASSETS HOLDING (SINGAPORE) PRIVATE LIMITED, Singapore (SG)

(72) Inventors: Zhongshen WU, Hangzhou, Zhejiang (CN); Deng ZHAO, Guangdong (CN)

(21) Appl. No.: 19/112,217

(22) PCT Filed: Sep. 15, 2023
(86) PCT No.: PCT/CN2023/119261

§ 371 Date: Mar. 14, 2025

(30) Foreign Application Priority Data
Sep. 16, 2022 (CN) 202211131870.3

(51) Int. Cl. H04N 21/44; H04N 21/433

(52) U.S. Cl. CPC H04N 21/44004; H04N 21/433

(57) ABSTRACT

The present application provides a method and apparatus for video display of a cloud service, a device, a storage medium, and a system, the method includes: if a client does not detect a user operation event to the cloud service at a first detection moment and a second detection moment, enabling a jitter buffer in local; storing a video stream received of the cloud service into the jitter buffer, where an interface of the cloud service is encoded as the video stream; and acquiring a video stream from the jitter buffer for decoding, and displaying a decoded video stream. By detecting the user operation event to the cloud service at the client side, it can be judged whether it is currently in an scene where the user interacts with the cloud service, if it is in a non-interactive scene, a video stream of the cloud service can be stored in the jitter buffer by adding jitter buffers, so as to resist an influence of network delay and jitter on a display quality of an image quality of a video, and reduce phenomenon of video jamming and frame loss, and the user experience is improved.

### CROSS-REFERENCE TO RELATED APPLICATIONS

This application is a National Stage of International Application No. PCT/CN2023/119261, filed on Sep. 15, 2023, which claims priority to Chinese Patent Application No. 202211131870.3, filed to China National Intellectual Property Administration on Sep. 16, 2022 and entitled “METHOD AND APPARATUS FOR VIDEO DISPLAY OF CLOUD SERVICE, DEVICE, STORAGE MEDIUM, AND SYSTEM”. The two applications are hereby incorporated by reference in their entireties.

### TECHNICAL FIELD

The present disclosure relates to the technical field of cloud computing and, in particular, to a method and apparatus for video display of a cloud service, a device, a storage medium, and a system.

### BACKGROUND

Cloud desktop is a computing-based desktop service on a cloud, desktop as a service (DaaS) is adopted to provide an easy-to-use, safe and efficient desktop office system on the cloud for a user. In fact, cloud service such as a cloud desktop and a cloud application has been widely used by the user in various application scenarios. A user who uses the cloud service can use a client to connect to the cloud service through a public network or a private line. The user's client does not need to install the cloud service, and a cloud service interface is transmitted to the client locally based on a communication protocol through a way of video streaming, and the user can use the cloud service in local.

For the user, requirements for the cloud service such as the cloud desktop and the cloud application are getting higher and higher, requirements for image quality are gradually improving, and a previous requirement for a standard definition video stream has been gradually improved to a requirement for an ultra-high-definition video stream. Ultra-high-definition image quality experience is better, but requirements for a network bandwidth are also much higher. In many practical environments, the delay and jitter of the network bandwidth are large, which cannot support a smooth transmission of the ultra-high-definition video stream.

### SUMMARY

Embodiments of the present disclosure provide a method and apparatus for video display of a cloud service, a device, a storage medium, and a system to ensure an image quality of a video stream of the cloud service.

In a first aspect, an embodiment of the present disclosure provides a method for video display of a cloud service, which is applied to a client and includes:
if a user operation event to the cloud service is not detected at a first detection moment and a second detection moment, enabling a jitter buffer in local;
storing a video stream received of the cloud service into the jitter buffer, where an interface of the cloud service is encoded as the video stream; and
acquiring a video stream from the jitter buffer for decoding, and displaying a decoded video stream.

In a second aspect, an embodiment of the present disclosure provides an apparatus for video display of a cloud service, which is applied to a client and includes:
a detecting module, configured to, if a user operation event to the cloud service is not detected at a first detection moment and a second detection moment, enable a jitter buffer in local;
a storing module, configured to store a video stream received of the cloud service into the jitter buffer, where an interface of the cloud service is encoded as the video stream; and
a decoding and displaying module, configured to acquire a video stream from the jitter buffer for decoding, and display a decoded video stream.

In a third aspect, an embodiment of the present disclosure provides an electronic device, including a memory, a processor, and a communication interface; where the memory stores an executable code, and when the executable code is executed by the processor, the processor is caused to execute the method for video display of the cloud service according to the first aspect.

In a fourth aspect, an embodiment of the present disclosure provides a non-transitory machine-readable storage medium, the non-transitory machine-readable storage medium stores an executable code, and when the executable code is executed by a processor of an electronic device, the processor is caused to at least implement the method for video display of the cloud service according to the first aspect.

In a fifth aspect, an embodiment of the present disclosure provides a video transmission system of a cloud service, including: a cloud server running a cloud service and a client corresponding to the cloud service;
where the cloud server is configured to perform video encoding on an interface of the cloud service to obtain a video stream of the cloud service, and send the video stream of the cloud service to the client; and
the client is configured to, if a user operation event to the cloud service is not detected at a first detection moment and a second detection moment, enable a jitter buffer in local; and store a video stream received of the cloud service into the jitter buffer, acquire a video stream from the jitter buffer for decoding, and display a decoded video stream.

In the embodiments of the present disclosure, the user operation event to the cloud service is continuously detected at the client side to judge whether it is currently in a scene where the user frequently interacts with the cloud service, if it is in a non-interactive scene (that is, the user operation event to the cloud service is not detected at the first detection moment and the second detection moment), a video stream of the cloud service can be stored in the jitter buffer by adding jitter buffers, so as to resist an influence of network delay and jitter on a display quality of an image quality of a video, and reduce phenomenon of video jamming and frame loss, and the user experience is improved.

### BRIEF DESCRIPTION OF DRAWINGS

In order to more clearly illustrate the technical solutions of the embodiments of the present disclosure or the prior art, the drawings needed to be used in the description of the embodiments or the prior art will be briefly introduced below. Obviously, the drawings in the following description are some embodiments of the present application, and for those skilled in the art, other drawings can be obtained according to these drawings without paying creative efforts.

FIG. 1 is a flowchart of a method for video display of a cloud service provided by an embodiment of the present disclosure.

FIG. 2 is a schematic application diagram of a method for video display of a cloud service provided by an embodiment of the present disclosure.

FIG. 3 is a flowchart of a method for video display of a cloud service provided by an embodiment of the present disclosure.

FIG. 4 is a flowchart of a method for video display of a cloud service provided by an embodiment of the present disclosure.

FIG. 5 is a schematic structural diagram of an apparatus for video display of a cloud service provided by an embodiment of the present disclosure.

FIG. 6 is a schematic structural diagram of an electronic device provided by an embodiment of the present disclosure.

### DESCRIPTION OF EMBODIMENTS

In order to make purposes, technical solutions and advantages of embodiments of the present disclosure more clear, the technical solutions in the embodiments of the present disclosure will be clearly and comprehensively described with reference to the accompanying drawings in the embodiments of the present disclosure. Obviously, the described embodiments are only a part of embodiments of the present disclosure, rather than all embodiments. Based on the embodiments in the present disclosure, all other embodiments obtained by one of ordinary skill in the art without paying creative efforts should belong to the protection scope of the embodiments of the present disclosure. In addition, sequences and steps of the following method embodiments is only an example, and is not strictly limited.

A video display method of a cloud service provided by an embodiment of the present disclosure can be executed by a client corresponding to the cloud service, and the client can be arranged in a user terminal such as a smart phone, a notebook computer etc.

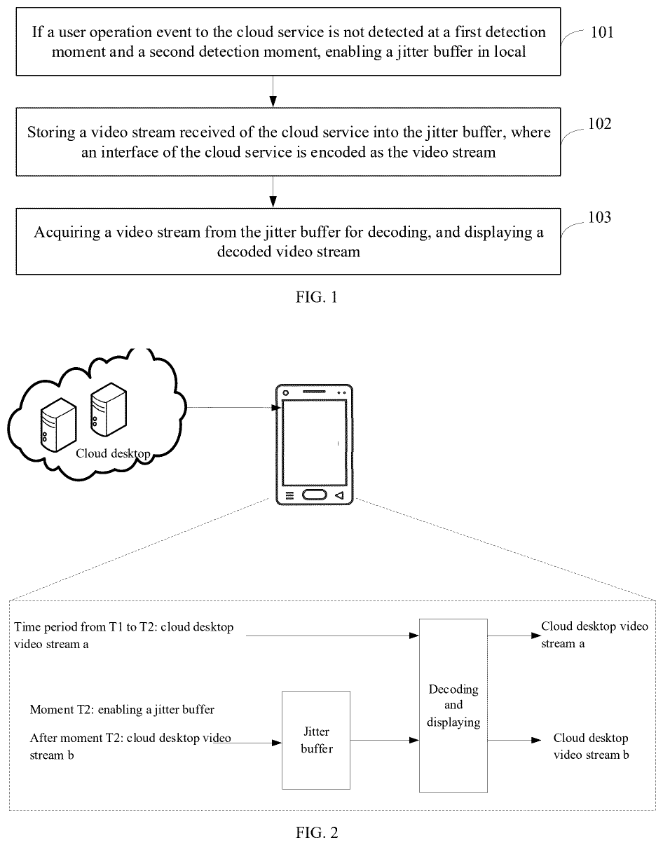

FIG. 1 is a flowchart of a method for video display of a cloud service provided by an embodiment of the present disclosure. As shown in FIG. 1, the method includes the following steps.

101, if a user operation event to the cloud service is not detected at a first detection moment and a second detection moment, enabling a jitter buffer in local.

102, storing a video stream received of the cloud service into the jitter buffer, where an interface of the cloud service is encoded as the video stream.

103, acquiring a video stream from the jitter buffer for decoding, and displaying a decoded video stream.

In practical application, cloud computing vendors provide many cloud servers in the cloud. In the embodiment of the present disclosure, a cloud service such as a cloud desktop and a cloud application, etc., can be deployed in the cloud servers.

In practical application, a user can use the client to connect to the cloud service such as the cloud desktop and the cloud application through a public network or a private line to use the cloud service. Specifically, the cloud service sends its screen video data to the client in a form of video stream, so that the user could see an interface of the cloud service through the client. The video stream of the cloud service is actually a video stream obtained by video coding and compression processing to the interface of the cloud service, and does not refer to the video stream loaded in the cloud service (such as a video played in a playing window of an interface).

Based on this, the cloud service mentioned in the embodiment of the present disclosure can be understood as: a service program running in a cloud server that transmits its complete interface to the client in a form of video stream based on a video stream push protocol. Since the cloud service is running in the cloud, the user can use the cloud service remotely without installing the cloud service at the client locally. In practical application, the cloud service could be, for example, a cloud desktop, a cloud mobile phone, and other cloud applications such as a cloud game application and a meta-universe application, etc.

In the cloud server, the computing capacity can be expanded at any time based on the user's requirements for a resolution ratio and a code rate of the above video stream, so as to support a cloud service video stream with multiple resolutions and code rates, such as a resolution ratio: 1080P and a code rate: 5 Mbps, such as a resolution ratio: 4K and a code rate: 10 Mbps, etc.

A network connection between the client and the cloud service (that is, the cloud server) is not always stable, and there is often network delay and jitter. The network delay is an important indicator in network transmission, which can measure the time required for data to move from one endpoint (such as a cloud service) to another endpoint (such as a client). Delay will affect the user experience, and may change due to many factors, such as a physical distance between two endpoints, an accessed switch, performance of a router itself, etc. Network jitter is caused based on a network delay, specifically, it is a manifestation that the delay time varies from long to short. The network jitter refers to a time difference between a maximum delay and a minimum delay. If the maximum delay is 20 ms and the minimum delay is 5 ms, then the network jitter is 15 ms, which mainly indicates the stability of the network connection. The network jitter is smaller the, the network connection is more stable However, in practical application, the user may propose use requirements of an ultra-high-definition video stream. The ultra-high-definition video stream generally refers to a video stream with 4K (4096*2160) or UHD (3840*2160), a bit rate of the ultra-high-definition video stream is much higher than that of the high-definition video stream and the standard-definition video, and needs enough network bandwidth to support smooth transmission.

When the user proposes higher quality requirements for image quality of the video stream of the cloud service (such as the requirement of the above ultra-high-definition video stream), the requirements for network bandwidth will be much higher accordingly. In many practical environments, the delay and jitter of the network (i.e., the network bandwidth) are large, which cannot support the smooth transmission of the ultra-high-definition video stream, and causes phenomena such as video jamming and frame jumping, etc.

Therefore, an embodiment of the present disclosure provides a solution of a displaying process to a video stream of a cloud service, so as to resist the adverse effects of the network delay and jitter on the display quality of the video stream.

The main idea of this solution is that: a user's operation behavior is detected at the client side, so as to judge whether it is in a scene where the user frequently interacts with the cloud service. If the scene is a frequent interactive scene, how to ensure the real-time transmission of video stream is considered preferentially, so that the user can see a response video stream of the cloud service to its interactive operation behavior in time. If the scene is not the frequent interactive scene, jitter buffers (such as jitter buffer) are added appropriately, so as to achieve a certain degree effect of resisting the network delay and jitter and, and reduce experience problems such as frame jumping and jamming caused by the network delay and jitter.

Specifically, the client could use the cloud service after establishing a connection with the cloud service. The video stream of the cloud service can be transmitted to the client for decoding and displaying. Under a normal circumstance, it is assumed that the client decodes the video stream received from the cloud service at a preset decoding rate (that is, 1× a decoding rate) and sends it to the display for displaying.

The client could detect whether there is an input of a user operation event (i.e., user operation behavior) with a set detection period, the set detection period could be set to a short time of microseconds, such as 10 microseconds. If a certain first detection moment is taken as a starting point, if no user operation event is detected at the first detection moment and thereafter at least a set time (for example, at least 3 seconds), it is considered that it is currently in a scene where the user does not interact frequently with the cloud service, and the client locally enables the jitter buffer. The set time may include a set number of detection periods, and it is assumed that a second detection moment is reached after the set time from the first detection moment. The client locally enabling the jitter buffer means that the client sets a dynamic (software-based) jitter buffer in the memory.

In practical application, the user operation event is, for example, that the user clicks a button in the interface of cloud service in a currently viewed video stream screen to create a file/folder, delete some contents in the interface, etc. An input way of the user operation event could be input though an input way such as a keyboard, mouse or touch way, a voice way, etc.

After the client enables the jitter buffer, a video stream received of the cloud service could be stored in the jitter buffer first, and then the client acquires the video stream from the jitter buffer at a certain decoding rate for decoding and displays a decoded video stream. In an implementation, the video stream could be acquired from the jitter buffer for decoding at the preset decoding rate.

The core idea of the jitter buffer is to increase an end-to-end delay in exchange for the fluency of the video stream, thus achieving the effect of resisting the network delay and jitter. That is to say, since the jitter buffer is enabled, the video stream of the cloud service needs to be stored in the jitter buffer for caching first, rather than being decoded immediately. The decoding is performed after caching for a period of time or a certain amount of data, although the delay of the video stream is increased, it can be decoded and displayed stably, thus realizing the smooth display effect of the video stream. However, if the network delay and jitter are large, the video stream of the cloud service will be decoded and displayed in real time when being received, rather than using the jitter buffer to cache the video stream. Due to the influence of network delay and jitter, the video stream of the cloud service is not evenly received, it may not be received in a short time, or many frames may be received in a short time, causing phenomena such as video jamming and frame jumping, etc.

In order to better realize the accumulation of video streams in the jitter buffer and realize the purpose of caching, in an implementation, in a preset time period after the jitter buffer is enabled or when an amount of data in the jitter buffer is lower than a preset amount of data, the video stream acquired from the jitter buffer could be decoded at a first decoding rate lower than the preset decoding rate. After the preset time period or after the amount of data in the jitter buffer is higher than the preset amount of data, the video stream acquired from the jitter buffer could be decoded at the preset decoding rate. The preset time period is a preset value such as 1 second and 2 seconds, etc. Taking the preset decoding rate being 1× the decoding rate as an example, the first decoding rate is, for example, 0.8× the decoding rate and 0.5× the decoding rate, etc. That is to say, after the jitter buffer is enabled, the video stream received of the cloud service is stored in the jitter buffer and decoded at a low decoding rate for a period of time, and then it recovers to decode the video stream received at a normal decoding rate.

In order to facilitate understanding, for example, the jitter buffer is understood as a water pool, and the decoding rate is equivalent to a water outlet rate. In a case that a water inlet rate is constant, the water outlet rate is small, and more water is stored in the water pool.

In addition, the client could also maintain a state identifier indicating whether the jitter buffer is used. When the client enables the jitter buffer, it records that the jitter buffer is in a use state, that is, a value of the status identifier is set to a value corresponding to the use state.

In the above embodiment, by detecting continuously a user operation event, when the user operation event is not detected for a continuous period time, it is considered that the user is currently in a scene that does not interact with the cloud service, which means that display delay of the video stream of the cloud service for a certain time has negligible influence on the user experience, because taking the cloud desktop as an example, if the user does not perform operation to the cloud desktop, the user will not feel the delay of the video stream. At this time, the jitter buffer is enabled, by catching the video stream for delay displaying, the problems of image jamming and frame jumping caused by the network delay and jitter can be solved.

In order to facilitate understanding, the solution provided by the above embodiment will be exemplified with reference to FIG. 2.

A video transmission system of cloud service provided in FIG. 2 includes a cloud server running a certain cloud service (such as cloud desktop) and a corresponding client. Starting from moment T1 after the client is connected with the cloud server network where the cloud desktop is located, the cloud desktop sends a cloud desktop video stream a to the client, moment T1 is taken as an initial detection moment, and the client detects the user operation event at moment T1, it is assumed that the operation event is not detected at this time, it is assumed that the client does not detect the user operation event at all detection moments after moment T1, such as within 3 seconds, and it is assumed that it takes 3 seconds after moment T1 to reach moment T2. It can be understood that during the time period from T1 to T2, the client continuously receives the cloud desktop video stream a, the client, when receiving the cloud desktop video stream a, decodes and displays the cloud desktop video stream a at 1× the decoding rate. At moment T2, the client determines that a jitter buffer needs to be enabled, so that a cloud desktop video stream b received since moment T2 will be stored in the jitter buffer for caching, the client can first acquire the cloud desktop video stream b from the jitter buffer for decoding and displaying at, for example, 0.8 times of the decoding rate in a short time (such as 1.5 seconds), and then acquire the cloud desktop video stream b from the jitter buffer for decoding and displaying at one times of the decoding rate normally.

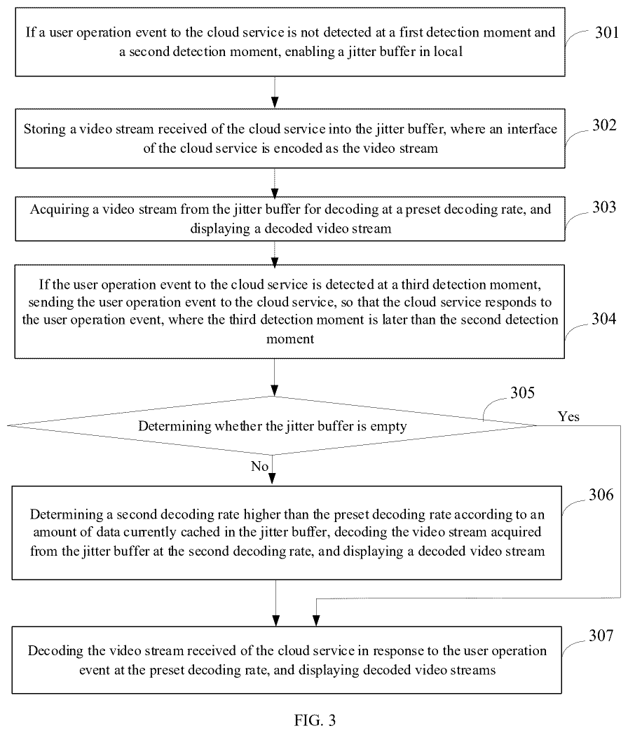

FIG. 3 is a flowchart of a method for video display of a cloud service provided by an embodiment of the present disclosure. As shown in FIG. 3, the method includes the following steps.

301, if a user operation event to the cloud service is not detected at a first detection moment and a second detection moment, enabling a jitter buffer in local.

302, storing a video stream received of the cloud service into the jitter buffer, where an interface of the cloud service is encoded as the video stream.

303, acquiring a video stream from the jitter buffer for decoding at a preset decoding rate, and displaying a decoded video stream.

304, if the user operation event to the cloud service is detected at a third detection moment, sending the user operation event to the cloud service, so that the cloud service responds to the user operation event, where the third detection moment is later than the second detection moment.

305, determining whether the jitter buffer is empty, if it is not empty, executing steps 306-307, otherwise, executing step 307.

306, determining a second decoding rate higher than the preset decoding rate according to an amount of data currently cached in the jitter buffer, decoding the video stream acquired from the jitter buffer at the second decoding rate, and displaying a decoded video stream.

307, decoding the video stream received of the cloud service in response to the user operation event at the preset decoding rate, and displaying decoded video streams.

In this embodiment, the executing processes of steps 301-303 refer to the relevant descriptions in the above embodiment, which will not repeated here.

In this embodiment, it is assumed that during a continuous time period: from the first detection moment to the second detection moment, the user operation event to the cloud service by the user is not detected, but the user operation event is detected at a certain detection moment after the second detection moment (called a third detection moment). At this time, on one hand, the client needs to send the user operation event to the cloud service, so that the cloud service responds to the user operation event; on the other hand, in a case that the user operation event occurs, the client needs to decode and display the video stream generated in response to the user operation event in time, so that the user can see a response result of the cloud service to its operation behavior almost in real time.

Since the user operation event to the cloud service by the user has not been detected from the first detection moment to the second detection moment, the client has enabled the jitter buffer, so when the user operation event occurs at the third detection moment, the video stream previously cached in the jitter buffer should be processed as soon as possible before the video stream generated in response to the user operation event can be decoded. Therefore, when the user operation event is detected at the third detection moment, it can first judge whether the jitter buffer is currently empty or not.

If the jitter buffer is empty, it means that there is no video stream cached in the jitter buffer, at this time, the client can directly decode and display the video stream received of the cloud service in response to the user operation event, and the decoding rate adopted at this time is the preset decoding rate (that is, 1× the decoding rate). It is noted that at this time, the video stream of the cloud service in response to the user operation event will not be stored in the jitter buffer for caching, because it needs to meet the real-time response to the user operation event.

If the jitter buffer is not empty, first, the second decoding rate higher than the preset decoding rate can be determined according to the amount of data currently cached in the jitter buffer, and the video stream acquired from the jitter buffer can be decoded and displayed at the second decoding rate; then, the video stream received of the cloud service in response to the user operation event is decoded and displayed at the preset decoding rate.

In practical application, the more data buffered in the jitter buffer, the higher the determined second decoding rate, so that the buffered video stream can be decoded and displayed at a higher decoding rate as soon as possible. The second decoding rate is, for example, 2× the decoding rate, 3× the decoding rate, etc.

To sum up, in the solution provided by this embodiment, when the user does not interact with the cloud service continuously, the jitter buffer is enabled to cache the video stream of the cloud service at this time, so as to solve the problems of video jamming and frame jumping caused by the network delay and jitter; and when the user interacts with the cloud service, the video cached in the jitter buffer is decoded and displayed as soon as possible, so as to decode and display the video in response to the user operation behavior in time, and to meet the real-time capability of interactive response of the user.

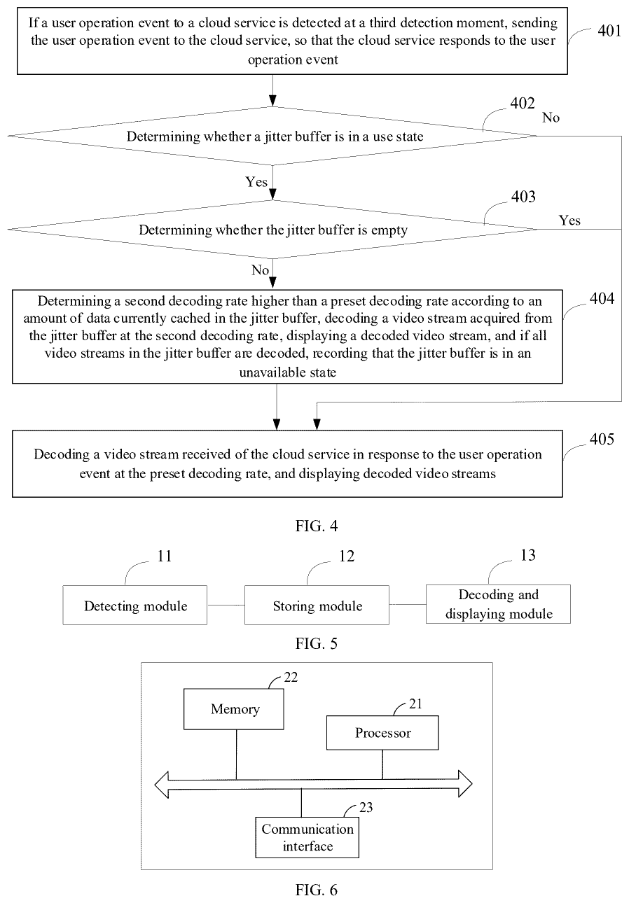

In the previous embodiment, it is assumed a situation where the jitter buffer is enabled first and then the user operation event is detected. The general processing flow after the user operation event is detected will be introduced in combination with the embodiment shown in FIG. 4.

FIG. 4 is a flowchart of a method for video display of a cloud service provided by an embodiment of the present disclosure. As shown in FIG. 4, the method includes the following steps.

401, if a user operation event to a cloud service is detected at a third detection moment, sending the user operation event to the cloud service, so that the cloud service responds to the user operation event.

402, determining whether a jitter buffer is in a use state, if yes, executing step 403, otherwise, executing step 405.

403, determining whether the jitter buffer is empty, if it is not empty, executing steps 404-405, otherwise, executing step 405.

404, determining a second decoding rate higher than a preset decoding rate according to an amount of data currently cached in the jitter buffer, decoding a video stream acquired from the jitter buffer at the second decoding rate, displaying a decoded video stream, and if all video streams in the jitter buffer are decoded, recording that the jitter buffer is in an unavailable state.

405, decoding a video stream received of the cloud service in response to the user operation event at the preset decoding rate, and displaying decoded video streams.

Based on the related descriptions in the above embodiment, when the client enables the jitter buffer, it can record that the jitter buffer is in a use state, that is, a value of a state identifier indicating whether the jitter buffer is used is set as a value corresponding to the use state. Based on this, it is assumed that the client detects the user operation event to the cloud service by the user at the current third detection moment, on one hand, the user operation event is sent to the cloud service, so that the cloud service responds to the user operation event, on the other hand, the client needs to judge whether the jitter buffer has been enabled at present and determine the amount of data in the jitter buffer.

When it is determined that the jitter buffer is not enabled based on the state identifier, the video stream received from the cloud service in response to the user operation event is directly decoded and displayed at the preset decoding rate.

When it is determined that the jitter buffer has been enabled based on the state identifier, whether the jitter buffer is empty is further judged. If the jitter buffer is empty, it means that there is no video stream cached in the jitter buffer, at this time, the client directly decodes and displays the video stream received of the cloud service in response to the user operation event at the preset decoding rate. If the jitter buffer is not empty, first, the second decoding rate higher than the preset decoding rate can be determined according to the amount of data currently cached in the jitter buffer, and the video stream acquired from the jitter buffer can be decoded and displayed at the second decoding rate until all the video streams cached in the jitter buffer are decoded and displayed, at this time, the value of the state identifier can be set as a value corresponding to an un-use state, then, the video stream received of the cloud service in response to the user operation event is decoded and displayed at the preset decoding rate. It can be understood that if the user operation event is not detected within a set time period (for example, 3 seconds exemplified above) after the third detection moment, at this time, the client enables the jitter buffer and sets the value of the state identifier as a value corresponding to the use state.

Apparatuses for video display device of a cloud service according to one or more embodiments of the present disclosure will be described in detail below. Those skilled in the art can understand that these apparatuses can be configured by the steps taught in the solutions using commercially available hardware components.

FIG. 5 is a schematic structural diagram of an apparatus for video display of a cloud service provided by an embodiment of the present disclosure. As shown in FIG. 5, the apparatus includes: a detecting module 11, a storing module 12, and a decoding and displaying module 13.

The detecting module 11 is configured to, if a user operation event to the cloud service is not detected at a first detection moment and a second detection moment, enable a jitter buffer in local.

The storing module 12 is configured to store a video stream received of the cloud service into the jitter buffer, where an interface of the cloud service is encoded as the video stream.

The decoding and displaying module 13 is configured to acquire a video stream from the jitter buffer for decoding, and display a decoded video stream.

In an implementation, the decoding and displaying 13 is specifically configured to acquire the video stream from the jitter buffer for decoding at a preset decoding rate.

In an implementation, the decoding and displaying 13 is specifically configured to decode the video stream acquired from the jitter buffer at a first decoding rate lower than the preset decoding rate within a preset time period after the jitter buffer is enabled or when an amount of data in the jitter buffer is lower than a preset amount of data; and decode the video stream acquired from the jitter buffer at the preset decoding rate after the preset time period or after the amount of data in the jitter buffer is higher than the preset amount of data.

In an implementation, the detecting module 11 is further configured to record that the jitter buffer is in a use state.

In an implementation, the detecting module 11 is further configured to: if the user operation event to the cloud service is detected at a third detection moment, send the user operation event to the cloud service, so that the cloud service responds to the user operation event, where the third detection moment is later than the second detection moment. The decoding and displaying module 13 is further configured to determine a second decoding rate higher than the preset decoding rate according to an amount of data currently cached in the jitter buffer; and decode the video stream acquired from the jitter buffer at the second decoding rate, and display a decoded video stream.

In an implementation, the decoding and displaying module 13 is further configured to decode the video stream acquired from the jitter buffer at the second decoding rate, and if all video streams in the jitter buffer are decoded, decode the video stream received of the cloud service in response to the user operation event at the preset decoding rate, and display decoded video streams.

In an implementation, the decoding and displaying module 13 is further configured to decode the video stream acquired from the jitter buffer at the second decoding rate, and if all the video streams in the jitter buffer are decoded, record that the jitter buffer is in an unavailable state.

In an implementation, the decoding and displaying module 13 is further configured to: determine whether the jitter buffer is in a use state in response to that the user operation event to the cloud service is detected at the third detection moment; if the jitter buffer is in the use state, determine the second decoding rate higher than the preset decoding rate according to the amount of data currently cached in the jitter buffer, decode the video stream acquired from the jitter buffer at the second decoding rate, if all video streams in the jitter buffer are decoded, decode the video stream received of the cloud service in response to the user operation event at the preset decoding rate, and display decoded video streams; if the jitter buffer is in an unavailable state, decode the video stream received of the cloud service in response to the user operation event at the preset decoding rate, and display the decoded video stream.

The apparatus shown in FIG. 5 could execute the steps in the foregoing embodiments, and the detailed execution process and technical effects are described in the foregoing embodiments, which will not be repeated here.

In a possible design, the structure of the apparatus for video display of the cloud service shown in FIG. 5 above can be realized as an electronic device. The electronic device is a user terminal device such as a smart phone and a notebook computer, etc. As shown in FIG. 6, the electronic device may include: a processor 21, a memory 22, and a communication interface 23. The memory 22 stores an executable code, and when the executable code is executed by the processor 21, the processor 21 is caused to at least implement the method for video display of the cloud service provided in the aforementioned embodiments.

In addition, an embodiment of the present disclosure provides a non-transitory machine-readable storage medium, where the non-transitory machine-readable storage medium storage medium stores an executable code, and when the executable code is executed by a processor of an electronic device, the processor is caused to at least implement the method for video display of the cloud service provided in the foregoing embodiments.

The apparatus embodiments described above are only schematic, where the units described as separate components may or may not be physically separated. Some or all of the modules can be selected according to actual needs to achieve the purpose of the solution of this embodiment. One of ordinary skill in the art can understand and implement without paying creative efforts.

Through the description of the above embodiments, those skilled in the art can clearly understand that each embodiment can be realized by adding a necessary general hardware platform, or by combining hardware and software. Based on this understanding, the essence of the above technical solution or the part that has contributed to the prior art can be embodied in a form of a computer product, and the present disclosure can take a form of computer program product implemented on one or more computer-usable storage medium (including but not limited to a disk storage, a compact disc read-only memory (CD-ROM), an optical storage, etc.) containing a computer-usable program code.

Finally, it should be explained that the above embodiments are only used to illustrate the technical solutions of the present disclosure, but not to limit it. Although the present disclosure has been described in detail with reference to the foregoing embodiments, those skilled in the art should understand that: it is still possible to modify the technical solutions described in the foregoing embodiments, or to replace some technical features with equivalents. However, these modifications or substitutions do not make the essence of the corresponding technical solutions deviate from the spirit and scope of the technical solutions of various embodiments of the present disclosure.

1. A method for video display of a cloud service, applied to a client and comprising:
if a user operation event to the cloud service is not detected at a first detection moment and a second detection moment, enabling a jitter buffer in local;
storing a video stream received of the cloud service into the jitter buffer, wherein an interface of the cloud service is encoded as the video stream; and
acquiring a video stream from the jitter buffer for decoding, and displaying a decoded video stream.

2. The method according to claim 1, wherein the acquiring the video stream from the jitter buffer for decoding comprises:
acquiring the video stream from the jitter buffer for decoding at a preset decoding rate.

3. The method according to claim 2, wherein the acquiring the video stream from the jitter buffer for decoding at the preset decoding rate comprises:
decoding the video stream acquired from the jitter buffer at a first decoding rate lower than the preset decoding rate within a preset time period after the jitter buffer is enabled or when an amount of data in the jitter buffer is lower than a preset amount of data; and
decoding the video stream acquired from the jitter buffer at the preset decoding rate after the preset time period or after the amount of data in the jitter buffer is higher than the preset amount of data.

4. The method according to claim 1, further comprising:
recording that the jitter buffer is in a use state.

5. The method according to claim 1, further comprising:
if the user operation event to the cloud service is detected at a third detection moment, sending the user operation event to the cloud service, so that the cloud service responds to the user operation event, wherein the third detection moment is later than the second detection moment;
determining a second decoding rate higher than the preset decoding rate according to an amount of data currently cached in the jitter buffer; and
decoding the video stream acquired from the jitter buffer at the second decoding rate, and displaying a decoded video stream.

6. The method according to claim 5, after the decoding the video stream acquired from the jitter buffer at the second decoding rate, further comprising:
if all video streams in the jitter buffer are decoded, decoding the video stream received of the cloud service in response to the user operation event at the preset decoding rate, and displaying decoded video streams.

7. The method according to claim 6, further comprising:
if all the video streams in the jitter buffer are decoded, recording that the jitter buffer is in an unavailable state.

8. The method according to claim 5, after the user operation event to the cloud service is detected at the third detection moment, further comprising:
determining whether the jitter buffer is in a use state;
wherein the determining the second decoding rate higher than the preset decoding rate according to the amount of data currently cached in the jitter buffer comprises:
if the jitter buffer is in the use state, determining the second decoding rate higher than the preset decoding rate according to the amount of data currently cached in the jitter buffer.

9. (canceled)

10. An electronic device, comprising a memory, a processor, and a communication interface; wherein the memory stores an executable code, and the processor, when executing the executable code is configured to:
if a user operation event to the cloud service is not detected at a first detection moment and a second detection moment, enable a jitter buffer in local;
store a video stream received of the cloud service into the jitter buffer, wherein an interface of the cloud service is encoded as the video stream; and
acquire a video stream from the jitter buffer for decoding, and display a decoded video stream.

11. A non-transitory machine-readable storage medium, wherein the non-transitory machine-readable storage medium stores an executable code, and when the executable code is executed by a processor of an electronic device, the processor is caused to execute the method for video display of the cloud service according to claim 1.

12. A video transmission system of a cloud service, comprising: a cloud server running a cloud service and a client corresponding to the cloud service;
wherein the cloud server is configured to perform video encoding on an interface of the cloud service to obtain a video stream of the cloud service, and send the video stream of the cloud service to the client; and
the client is configured to, if a user operation event to the cloud service is not detected at a first detection moment and a second detection moment, enable a jitter buffer in local; and store a video stream received of the cloud service into the jitter buffer, acquire a video stream from the jitter buffer for decoding, and display a decoded video stream.

13. The electronic device according to claim 10, wherein the processor is configured to:
acquire the video stream from the jitter buffer for decoding at a preset decoding rate.

14. The electronic device according to claim 13, wherein the processor is configured to:
decode the video stream acquired from the jitter buffer at a first decoding rate lower than the preset decoding rate within a preset time period after the jitter buffer is enabled or when an amount of data in the jitter buffer is lower than a preset amount of data; and
decode the video stream acquired from the jitter buffer at the preset decoding rate after the preset time period or after the amount of data in the jitter buffer is higher than the preset amount of data.

15. The electronic device according to claim 10, wherein the processor is configured to:
record that the jitter buffer is in a use state.

16. The electronic device according to claim 10, wherein the processor is configured to:
if the user operation event to the cloud service is detected at a third detection moment, send the user operation event to the cloud service, so that the cloud service responds to the user operation event, wherein the third detection moment is later than the second detection moment;
determine a second decoding rate higher than the preset decoding rate according to an amount of data currently cached in the jitter buffer; and
decode the video stream acquired from the jitter buffer at the second decoding rate, and display a decoded video stream.

17. The electronic device according to claim 16, wherein the processor is configured to:
if all video streams in the jitter buffer are decoded, decode the video stream received of the cloud service in response to the user operation event at the preset decoding rate, and display decoded video streams.

18. The electronic device according to claim 17, wherein the processor is configured to:
if all the video streams in the jitter buffer are decoded, record that the jitter buffer is in an unavailable state.

19. The electronic device according to claim 16, wherein the processor is configured to:
determine whether the jitter buffer is in a use state; and
if the jitter buffer is in the use state, determine the second decoding rate higher than the preset decoding rate according to the amount of data currently cached in the jitter buffer.

20. The non-transitory machine-readable storage medium according to claim 11, wherein the processor is configured to perform the following operation:
acquiring the video stream from the jitter buffer for decoding at a preset decoding rate.

21. The non-transitory machine-readable storage medium according to claim 20, wherein the processor is configured to perform the following operation:
decoding the video stream acquired from the jitter buffer at a first decoding rate lower than the preset decoding rate within a preset time period after the jitter buffer is enabled or when an amount of data in the jitter buffer is lower than a preset amount of data; and
decoding the video stream acquired from the jitter buffer at the preset decoding rate after the preset time period or after the amount of data in the jitter buffer is higher than the preset amount of data.
